(19) United States
(12) Patent Application Publication
(10) Pub. No.: US 2005/0225642 A1
(43) Pub. Date: Oct. 13, 2005

(54) Apparatus and method for the determination of positioning coordinates for semiconductor substrates

(75) Inventor: Burkhard Spill, Ebsdorfergrund (DE)

Correspondence Address: HOUSTON ELISEEVA, 4 MILITIA DRIVE, SUITE 4, LEXINGTON, MA, 02421, US

(73) Assignee: Leica Microsystems Semiconductor GmbH, Wetzlar (DE)

(21) Appl. No.: 11/083,718

(22) Filed: Mar. 18, 2005

(30) Foreign Application Priority Data
Apr. 10, 2004 (DE) DE102004017691.4
Sep. 16, 2004 (DE) DE102004044785.3

(51) Int. Cl. H04N 5/225

(52) U.S. Cl. 348/207.99

(57) ABSTRACT

An apparatus (2) and a method for the determination of positioning coordinates for at least one semiconductor substrate (6) are disclosed. A digital camera (11) for acquiring an image of the surface (4) of the semiconductor substrate (6) is provided. A computer system is provided, having a display (41) on which the image of the surface (4) of the semiconductor substrate (6) is presentable. By way of an input means (44), a user can mark at least one site (34) of interest on the surface (4) of the semiconductor substrate (6). A measuring machine (24) then automatically travels to the at least one defined site (34) and carries out the desired measurement or examination.

### RELATED APPLICATIONS

This application claims priority of the German patent applications 10 2004 017 691.4 and 10 2004 044 785.3 which are incorporated by reference herein.

### FIELD OF THE INVENTION

The invention concerns an apparatus for the determination of positioning coordinates for semiconductor substrates.

The invention further concerns a method for the determination of position coordinates for at least one semiconductor substrate.

### BACKGROUND OF THE INVENTION

Patent Abstracts of Japan, Publication No. 10 284576 discloses a conveyor arrangement for a wafer. Arranged directly above the wafer is a CCD camera with which a two-dimensional image of the entire wafer can be acquired. No connection is disclosed, however, between the image data acquired by the CCD camera and a measuring machine.

European Patent Application EP 0 977 029 A1 discloses an apparatus for the inspection of patterns on semiconductor substrates. An illumination system and a CCD camera are arranged above the surface of the wafer. The arrangement of the illumination system and of the CCD camera is such that their optical axes are inclined in identical fashion with respect to the line normal to the surface of the wafer. Acquisition of an overview image of the entire surface of a wafer is not provided for here.

### SUMMARY OF THE INVENTION

It is the object of the invention to create an apparatus with which selected sites on the surface of a semiconductor substrate can be quickly and reliably positionable for a detailed measurement by a measuring machine.

This object is achieved by way of an apparatus for the determination of positioning coordinates for at least one semiconductor substrate comprises: an acquisition means for digital images of the surface of the semiconductor substrate; a computer system with a display on which the image of the surface of the semiconductor substrate is presented; an input means with which a user marks at least one site of interest on the surface of the semiconductor substrate as shown on the display; and a stage, displaceable in a X direction and a Y direction, that carries the semiconductor substrate and positions the semiconductor substrate with respect to a measuring machine in the at least one marked site.

A further object of the invention is to create a method with which selected sites on the surface of a semiconductor substrate are quickly and reliably positionable for a detailed measurement.

This object is achieved by way of a method for the determination of position coordinates for at least one semiconductor substrate using a digital camera, comprising the steps of:
aligning the semiconductor substrate in order to obtain a correlation between the coordinates of the semiconductor substrate and of a measuring machine;
acquiring an image of the entire surface of the semiconductor substrate,
presenting the image of the surface of the semiconductor substrate on a display;
marking by the user, via an input means, at least one site on the surface of the semiconductor substrate; and
transferring a displaceable stage of a measuring machine and thereby positioning of the measuring machine at the at least one marked site on the surface of the semiconductor substrate; whereby the stage is moved successively to the at least one marked site in order to carry out the specific measurement there.

It is advantageous if the apparatus for the determination of positioning coordinates for at least one semiconductor substrate encompasses an acquisition means for acquiring an image of the surface of the semiconductor substrate. It is useful for the user if a computer system, having a display on which the image of the surface of the semiconductor substrate is presentable, is provided. An input means enables the user to mark at least one site of interest on the surface of the semiconductor substrate. A measuring machine then automatically travels to the at least one defined site.

It is advantageous if the acquisition means is a digital camera having a CCD chip. Also provided is a prealigner that aligns the semiconductor substrate with respect to a coordinate system associated with the apparatus. The digital camera is then provided in the region of the prealigner in order to obtain there the digital images of the semiconductor substrate.

It is likewise advantageous if a digital video camera is used as the acquisition means instead of a digital camera having a CCD chip. The prealigner moves the semiconductor substrate (rotates, pivots, wobbler function) and aligns it with respect to a coordinate system associated with the apparatus. The digital video camera is then provided in the region of the prealigner in order to obtain there a video sequence of the moving semiconductor substrate. The advantage resulting from this is that the image having the best illumination can be selected from the video sequence. The video sequence is storable, so that the user can call up the image that is most suitable.

The measuring machine associated with the apparatus encompasses a stage, displaceable in the X direction and Y direction, that carries the semiconductor substrate and positions the semiconductor substrate with respect to the measuring machine in the at least one site of interest. The position data are transferred, in this context, from the at least one site of interest of the digital image of the semiconductor substrate to the stage control system in order to position the stage accordingly. If the measuring machine is displaceable, it can also be positioned correspondingly.

The digital camera possesses a resolution of 3 million pixels, and each acquired image has a file size of approximately 9.3 MB per image in the .bmp format.

The apparatus can be embodied as a standalone variant that, in a semiconductor fabrication system, distributes the wafer coordinates of sites that are to be examined more closely, as an ASCII file, to other measuring systems. It is also possible to store the images acquired with the digital camera so that they are available to process engineers as information.

The method is advantageously embodied in such a way that firstly an alignment of the semiconductor substrate is performed in order to obtain a correlation between the coordinates of the semiconductor substrate and of a measuring machine. After alignment, acquisition of an image of the entire surface of the semiconductor substrate is performed. The image of the surface of the semiconductor substrate is presented on a display. The user selects at least one defined site on the surface of the semiconductor substrate via an input means. On the basis of the selection, positioning of the measuring machine at the at least one site on the surface of the semiconductor substrate selected by the user is accomplished, in order to carry out a specific measurement at that site.

Further advantageous embodiments of the apparatus and the method are evident from the dependent claims.

### BRIEF DESCRIPTION OF THE DRAWINGS

The subject matter of the invention is depicted schematically in the drawings and will be described below with reference to the Figures, in which:

FIG. 1 schematically depicts a portion of the apparatus for the determination of position coordinates for at least one semiconductor substrate;

FIG. 2 shows a schematic configuration of the apparatus for the determination of position coordinates for at least one semiconductor substrate, the apparatus being implemented as a standalone variant;

FIG. 3 shows a schematic configuration of the apparatus for the determination of position coordinates for at least one semiconductor substrate, the apparatus being integrated into a measuring machine for the semiconductor industry;

FIG. 4 is a schematic view of an overview image of the entire surface of a semiconductor substrate that is implemented as a wafer having patterned elements;

FIG. 5 is a digitally magnified view of the at least one site on the wafer at which a detailed examination or measurement is to be performed;

FIG. 6 schematically depicts an interface that is presented to the user on a display;

FIG. 7 schematically depicts, at a low optical magnification, the region around the site at which the detailed examination or measurement is to be carried out;

FIG. 8 schematically depicts, at a high optical magnification, the region around the site at which the detailed examination or measurement is to be carried out;

FIG. 9 depicts a digitally acquired complete image of the surface of a semiconductor substrate on which at least one unpatterned layer is applied;

FIG. 10 is a depiction correlating the contour lines from the layer thickness measurement with the digitally acquired complete image of the surface of the semiconductor substrate.

### DETAILED DESCRIPTION OF THE INVENTION

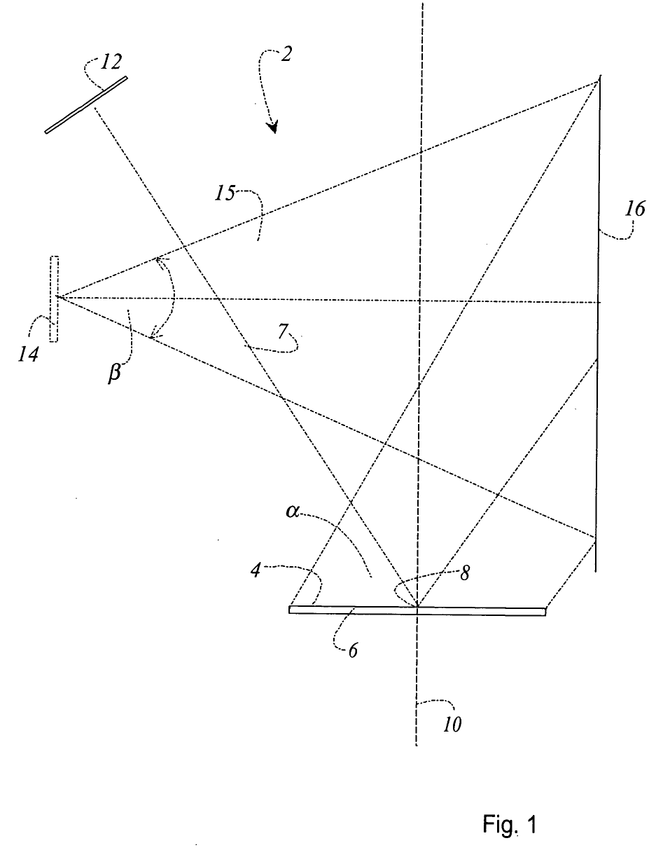

FIG. 1 schematically depicts a configuration of an apparatus 2 for acquiring a complete overview image of a surface 4 of a semiconductor substrate 6. Semiconductor substrate 6 can be a wafer, and can therefore be round. The semiconductor substrate can also be a mask. It is also conceivable for the semiconductor substrate to be a carrier for a plurality of micromechanical components. The apparatus according to the present invention is also appropriate in other technology sectors in which patterned samples are used. Position-dependent process inspections are carried out in the following technology sectors: in the production of integrated circuits from silicon semiconductors; in the production of read heads for hard drives; in the production of micromechanical and microelectronic components; in the production of LCD displays; in mask production; in the production of printing heads for inkjet technology; in the production of optoelectronic components (III-V semiconductor technology, LEDs, semiconductor lasers); and in the production of DVDs and in DVD technology (quality and process inspection).

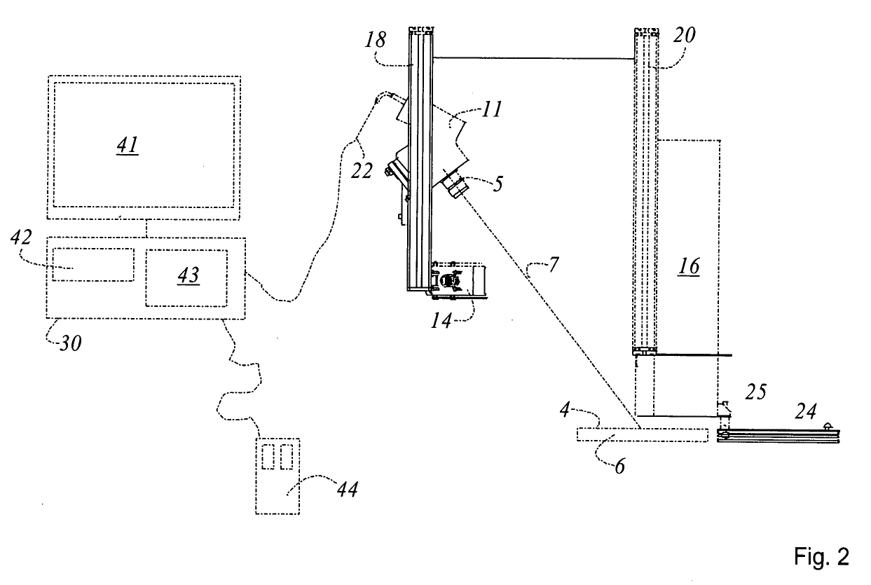

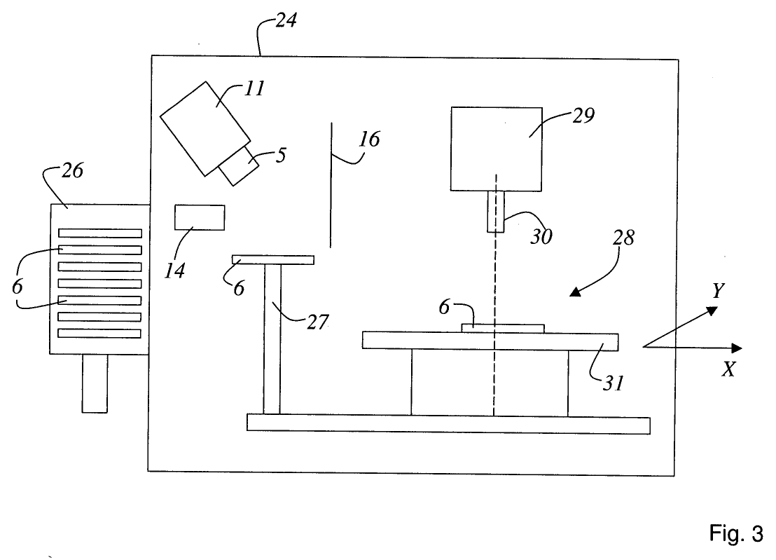

Apparatus 2 has associated with it a digital camera 11 having a CCD chip 12 (see FIG. 2 or FIG. 3). An illumination device 14 is provided on the same side below CCD chip 12. A diffuser screen 16 is also arranged opposite illumination device 14. Illumination device 14 emits a light cone 15 at an angle [beta] so that light cone 15 exclusively strikes diffuser screen 16. Digital camera 11 acquires an overview image of the wafer or semiconductor substrate.

FIG. 2 shows a schematic configuration of apparatus 2 for the determination of position coordinates for at least one semiconductor substrate 6, apparatus 2 being implemented as a standalone variant. The complete image of surface 4 of a semiconductor substrate 6 is acquired with the digital camera. Digital camera 11 is equipped with an objective 5 that defines an optical axis 7. In this embodiment, digital camera 11 is arranged in such a way that optical axis 7 extends through center point 8 of semiconductor substrate 6. Digital camera 11 is arranged on first rail 18 above illumination device 14. Provided opposite first rail 18 is a second rail 20 on which diffuser screen 16 is displaceably mounted. The image data acquired by camera 11 are transferred via a cable 22 to a computer 30. The image of surface 4 of semiconductor substrate 6 is visualized for the user on a display 41. By way of an input unit 44, the user can select a defined site on surface 4 of semiconductor substrate 6 in order to carry out a closer examination or measurement there. The image of surface 4 of semiconductor substrate 6 presented on display 41 is distortion-free. Digital camera 11 acquires the complete image of surface 4 of semiconductor substrate 6 with distortion. This distortion must be corrected prior to presentation on display 41. A corresponding processor 42 is provided for that purpose in computer 30. The user can store the distortion-free image of surface 4 of semiconductor substrate 6 in a memory 43 of computer 30. Although the description refers to only one computer 30, it is self-evident to one skilled in the art that processor 42 and memory 43 can also be part of an overall network in a factory for semiconductor production. The possibility also exists of storing the distortion-free image of surface 4 of semiconductor substrate 6 at 300 KB in a jpg format or at 12 MB in a high-resolution TIFF format.

FIG. 3 shows a schematic configuration of apparatus 2 for the determination of position coordinates for at least one semiconductor substrate 6, apparatus 2 being integrated into a measuring machine 24 for the semiconductor industry. A supply magazine 26 for semiconductor substrates 6 is associated with measuring machine 24. A robot arm (not depicted) removes semiconductor substrates 6 from supply magazine 26 and transfers them into measuring machine 24. In measuring machine 24, semiconductor substrates 6 are transferred onto a prealigner 27 that aligns semiconductor substrates 6. From prealigner 27, semiconductor substrates 6 are transferred into an inspection unit 28. In inspection unit 28, specific sites on a semiconductor substrate 6 are examined more closely or microscopically. In the embodiment depicted here, measuring machine 24 encompasses an inspection unit 28 that, in the embodiment depicted here, comprises a microscope 29 having an objective 30. Semiconductor substrate 6 is placed on an X-Y stage 31 that is displaced to the position or those positions of semiconductor substrate 6 at which the closer examination is to be carried out. In measuring machine 24, prealigner 27 has digital camera 11, illumination device 14, and diffuser 16 associated with it. An overview image of semiconductor substrate 6 is acquired with digital camera 11. Measuring machine 24 can be an inspection unit 28, an apparatus for layer thickness measurement, or an apparatus for determining the critical dimension (CD) of features on semiconductor substrates.

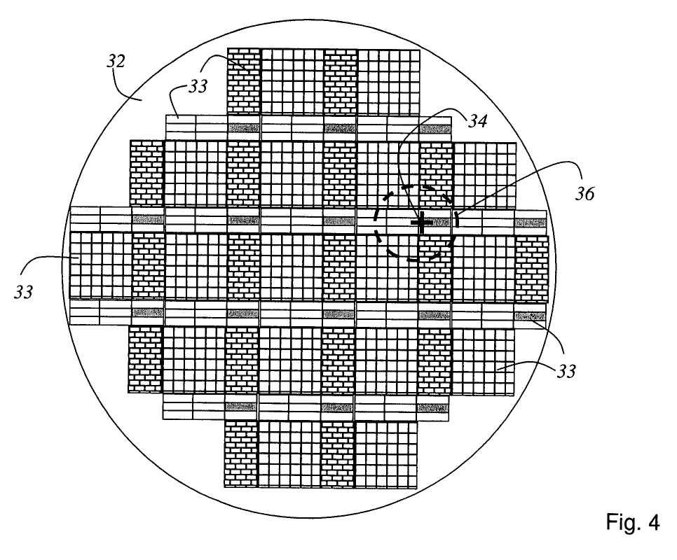

The overview image of the semiconductor substrate is depicted in FIG. 4. Digital camera 11 acquires the complete image of surface 4 of semiconductor substrate 6 with distortion. This distortion must be corrected prior to presentation on display 41. A corresponding processor 42 is provided for that purpose in computer 35. The user can store the distortion-free image of surface 4 of semiconductor substrate 6 in a memory 43 of computer 30. In the embodiment shown in FIG. 4, semiconductor substrate 6 is a wafer 32. Multiple patterned elements 33 are applied on surface 4 of wafer 32. The individual patterned elements 33 are made up of rectangular sub-patterns called dice. By way of an input unit 44 (see FIG. 2), the user can select at least one defined site 34 on surface 4 of wafer 32. In the embodiment depicted here, the user places a cross 36 on the at least one defined site 34 using input unit 44. Although only a cross 36 is depicted here for marking, it is self-evident that other symbols can be used for marking. The at least one site 34 of interest on surface 4 of semiconductor 6 marked by the user with input means 44 is automatically traveled to by measuring machine 24.

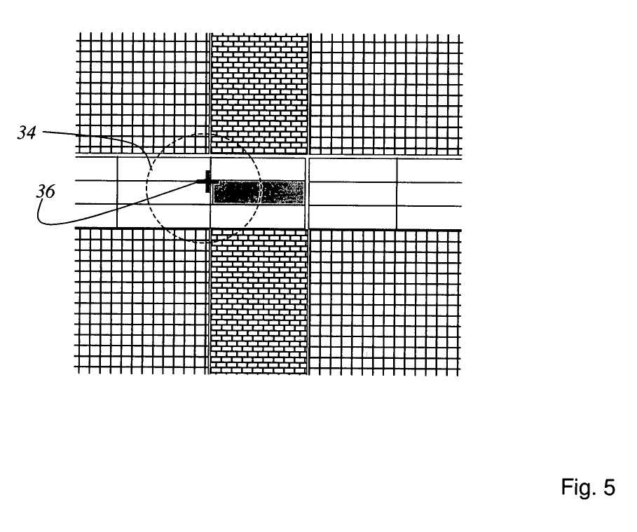

FIG. 5 is a digitally magnified view of the at least one site 34 on the wafer at which a detailed examination or measurement is to be performed. The user can position cross 36 somewhat more accurately in order to achieve better localization of the defined site 34. The digital magnification can be selected arbitrarily by the user. By shifting site 34, its coordinates can then be transferred into the coordinates of X-Y stage 31. X-Y stage 31 is then displaced in such a way that the site to be examined is positioned more accurately in inspection unit 28.

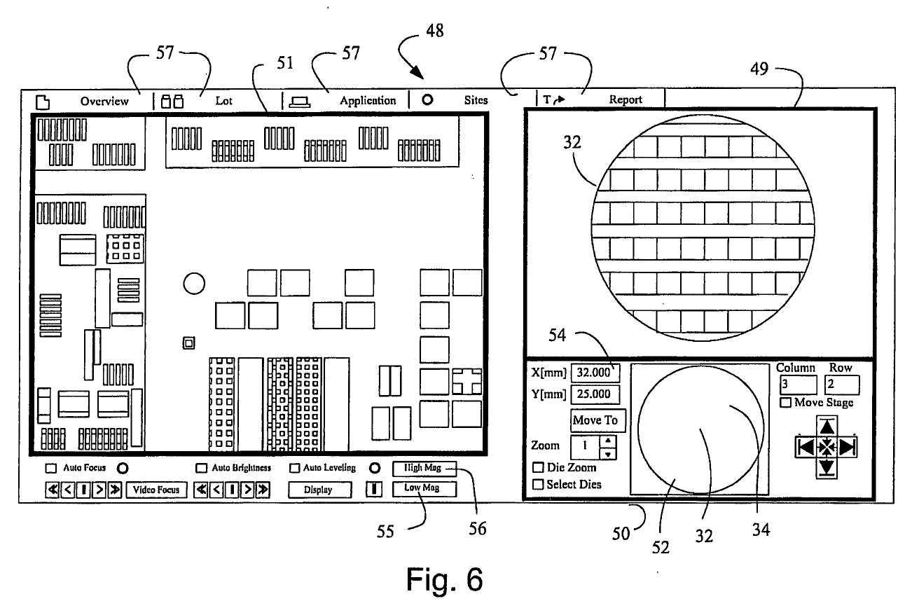

FIG. 6 is a schematic depiction of an interface 48 that is presented to the user on display 41. Interface 48 is subdivided substantially into a first segment 49, a second segment 50, and a third segment 51. The image of surface 4 of semiconductor substrate 6 is presented in first segment 48. Semiconductor substrate 6 is in this case a wafer 32 on which multiple features are applied. Second segment 50 is provided below first segment 49. In second segment 50, a symbol 52 of wafer 32 is depicted. The center of wafer 32 is marked on symbol 52. The defined site 34 at which cross 36 for selection of that site 34 is located marks this site. Cross 36 is conveyed with input unit 44 to the site selected by the user. Provided to the left of symbol 52 of wafer 32 is a position indicator 54 that presents to the user, in readable form, the instantaneous position of cross 36 on surface 4 of wafer 32. An enlarged image of the site 34 at which cross 36 is located on surface 4 of wafer 32 is presented in magnified fashion in third segment 51. Magnification is performed with inspection unit 28. A first switch 55 and a second switch 56 are provided below third segment 51. First switch 55 bears the designation “Low Mag” and second switch 56 bears the designation “High Mag.” “Low Mag” means that inspection unit 28 acquires an image of the site of interest at low magnification. “High Mag” means that inspection unit 28 acquires an image of the site of interest at high magnification. Provided above third segment 51 are multiple tabs 57 with which various functions can be invoked. One tab is labeled “Overview”; activating this causes an overview image of wafer 32 or semiconductor substrate 6 to be acquired. A further tab is labeled “Lot”; when this is activated, multiple wafers 32 or semiconductor substrates 6 of a lot are examined according to the same protocol. Another tab is labeled “Application”; when this is activated, a specific measurement application is applied to the at least one wafer 32 or semiconductor substrate 6. One tab is labeled “Sites”; when it is activated, multiple selected sites 34 on a wafer 32 or a semiconductor substrate 6 can be successively traveled to. A final tab is labeled “Report”; when it is activated, for example, the measurement results from the selected site 34 on a wafer 32 or a semiconductor substrate 6 can be stored. The user can likewise store the individual overview images.

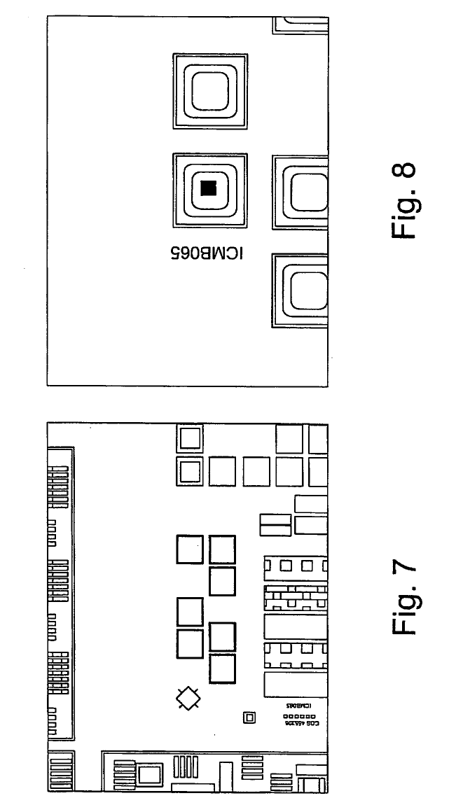

FIG. 7 depicts the region around site 34 at which the detailed examination or measurement is to be carried out. This site 34 is imaged at a low optical magnification (“Low Mag”). For a more precise depiction, as depicted in FIG. 8, site 34 at which the detailed examination or measurement is to be carried out is imaged at a high optical magnification and presented on display 41.

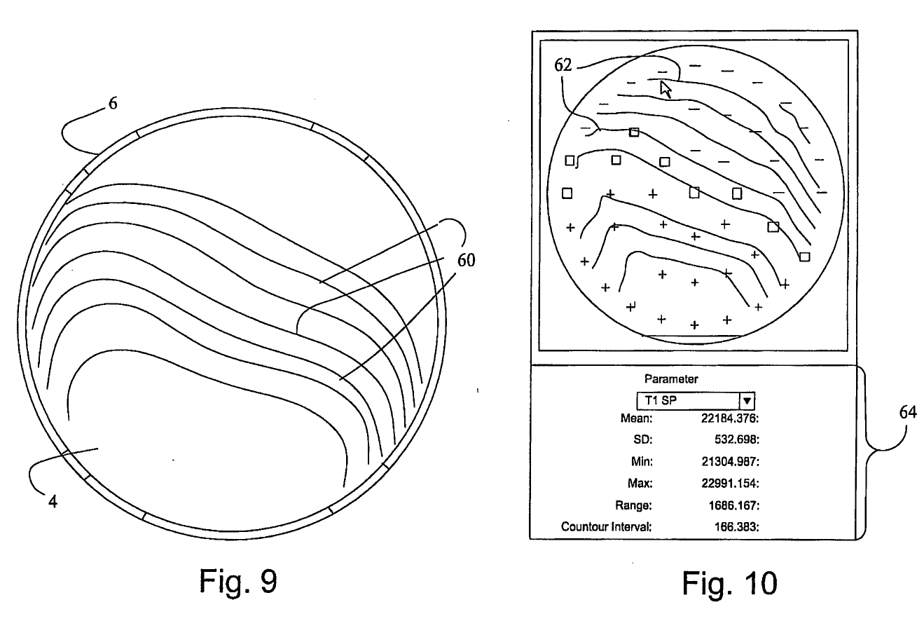

FIG. 9 depicts a digitally acquired complete image of surface 4 of a semiconductor substrate 6. At least one unpatterned layer is applied on semiconductor substrate 6. In the digital image, the different layer thicknesses are apparent on the basis of the different colors on surface 4 of semiconductor substrate 6. In the black-and-white depiction in FIG. 9, the different thicknesses are apparent as lines 60 at which the grayscale values change. FIG. 10 schematically depicts the image of the surface of the semiconductor substrate of FIG. 9. A user can specify multiple points on the surface of the wafer for a layer thickness measurement. The result obtained from the layer thickness measurement is what is depicted in FIG. 10. In the simplified depiction, regions of identical thickness are marked with a respective contour line 62. Measurement results 64 in numerical form are presented beneath the presentation of contour lines 62.

1. An apparatus for the determination of positioning coordinates for at least one semiconductor substrate comprises: an acquisition means for digital images of the surface of the semiconductor substrate; a computer system with a display on which the image of the surface of the semiconductor substrate is presented; an input means with which a user marks at least one site of interest on the surface of the semiconductor substrate as shown on the display; and a stage, displaceable in a X direction and a Y direction, that carries the semiconductor substrate and positions the semiconductor substrate with respect to a measuring machine in the at least one marked site.

2. The apparatus as defined in claim 1, wherein the acquisition means is a digital camera having a CCD chip a digital video camera.

3. The apparatus as defined in claim 1, wherein a prealigner is provided that aligns the semiconductor substrate with respect to a coordinate system associated with the apparatus.

4. The apparatus as defined in claim 1, wherein the digital camera 11 possesses a resolution of 3 million pixels; and each acquired image has a file size of approximately 9.3 MB per image in the .bmp format.

5. The apparatus as defined in claim 1, wherein the semiconductor substrate is a patterned wafer, or a wafer having at least one applied layer.

6. The apparatus as defined in claim 1, wherein the apparatus is incorporated into a measurement system for the semiconductor industry.

7. The apparatus as defined in claim 1, wherein the apparatus is integrated into a device for layer thickness measurement.

8. The apparatus as defined in claim 1, wherein the apparatus is a standalone variant that, in a semiconductor fabrication system, distributes the wafer coordinates of sites that are to be examined more closely, as an ASCII file, to other measuring systems.

9. A method for the determination of position coordinates for at least one semiconductor substrate using a digital camera, comprising the steps of:
aligning the semiconductor substrate in order to obtain a correlation between the coordinates of the semiconductor substrate and of a measuring machine;
acquiring an image of the entire surface of the semiconductor substrate,
presenting the image of the surface of the semiconductor substrate on a display;
marking by the user, via an input means, at least one site on the surface of the semiconductor substrate; and
transferring a displaceable stage of a measuring machine and thereby positioning of the measuring machine at the at least one marked site on the surface of the semiconductor substrate; whereby the stage is moved successively to the at least one marked site in order to carry out the specific measurement there.

10. The method as defined in claim 9, wherein the acquisition of an image of the entire surface of the semiconductor substrate is carried out using a digital camera or a digital video camera.

11. The method as defined in claim 9, wherein with the input means, a cursor is positioned at the at least one site selected by the user on the surface of the semiconductor substrate.

12. The method as defined in claim 9, wherein in the context of the examination of multiple identical semiconductor substrates of a stack, for one of those semiconductor substrates the sites on the semiconductor substrate are selected by the user and the respectively associated coordinates are ascertained; and those ascertained coordinates are applied for all semiconductor substrates of the stack.

13. The method as defined in claim 9, wherein the semiconductor substrate is a wafer that is provided with at least one layer on the surface, or wherein the wafer having multiple patterned elements, the wafer being provided with at least one layer on the surface, or the wafer that is provided with at least one patterned element on the surface.

14. The method as defined in claim 1, wherein a “Low Mag” or “High-Mag” presentation of the at least one defined site is selected by the user on the display.

15. The method as defined in claim 14, wherein at “Low Mag,” the surface of the wafer having the patterned elements is imaged over an area of 1 mm to 1.3 mm.

16. The method as defined in claim 14, wherein with the switchover to “High Mag,” the site on the surface of the wafer at which the measurement is to be carried out is positioned more accurately; and its coordinates are then stored.

17. The method as defined in claim 27, wherein at “High Mag,” the surface of the wafer (32) of the semiconductor substrate is imaged over an area of 0.24 mm×0.32 mm.

18. The method as defined in claim 9, wherein the method is integrated into a standalone apparatus; and in a semiconductor fabrication system, the coordinates of the defined sites on the surface of semiconductor substrates that are to be examined more closely are transmitted as an ASCII file to other measurement systems.
